(19) United States
(12) Patent Application Publication
(10) Pub. No.: US 2007/0129071 A1
(43) Pub. Date: Jun. 7, 2007

(54) Distributed cell balancing

(75) Inventor: Joseph Shapira, Haifa (IL)

Correspondence Address: Martin D Moynihan;Prtsi Inc, P O Box 16446, Arlington, VA, 22215, US

(73) Assignee: Celletra Ltd., Yokneam llit (IL)

(21) Appl. No.: 10/575,707

(22) PCT Filed: Sep. 28, 2004
(86) PCT No.: PCT/IL04/00902

§ 371 Date: Apr. 13, 2006

Related U.S. Application Data
(60) Provisional application No. 60/513,586, filed on Oct. 24, 2003.

(51) Int. Cl. H04Q 7/20

(52) U.S. Cl. 455/422.1

(57) ABSTRACT

A load balancing system for dynamic balancing of load between sectors of a sectored cellular base station, comprises a plurality of repeaters with local coverage in the sectors, and a switching matrix, for associating between the repeaters and the base station, and for allowing the repeaters to be switched between different sectors. If the system uses the base station assigned frequency band for communication with the repeaters then the system can be provided with minimal interference as an add-on to a legacy base station. An add-on may also be provided using microwave frequency and dedicated antennas.

### FIELD AND BACKGROUND OF THE INVENTION

The present invention relates to load balancing within cells in cellular telephony systems and, more particularly, but not exclusively to a system for dynamically balancing load traffic between sectors in given cells.

Conventional cellular networks employ an architecture which divides a geographical area into coverage areas, called cells, and a base station is placed at the center of the cell to serve the cellular traffic within the cell.

To increase the capacity (the total data or the total number of users served) the cell is further divided into sectors (typically 3 sectors), which are served from the same base location, using dedicated baseband resources, transceivers and directional antennas, per sector.

A coverage problem might arise due to “radio holes”, that is regions within the cell/sector which suffer large propagation losses due to uneven topography or buildings, impairing the quality of service. This effect is particularly important in urban areas.

Another problem which might arise is “hot spots”, where a large concentration of users, usually not in the vicinity of the base station, causes an excessive load on the cell's radio resources.

Both problems can be addressed using repeaters.

Repeaters can improve coverage of “radio holes” by placing them in geographic locations which have good radio coverage of the problematic areas, while maintaining good connectivities to the base station.

Similarly, repeaters can increase the capacity available to these hot spots by reducing the required transmit power (both uplink and downlink) to achieve a good quality of service. This is especially relevant to CDMA systems, where the capacity is interference limited.

In both cases, the repeaters are deployed within the sector to improve the coverage and the capacity of the sector and optimize the sector's radio resources allocation.

However, while each sector might be optimized with regards to its own resource allocation, different sectors within the cell may at times be heavily loaded, requiring additional capacity, while other sectors might be lightly loaded, thus having spare capacity.

This load imbalance between the sectors could be the result of non-optimal network design, or due to changes in communication patterns since the cellular system was originally installed. It could simply be due to the opening of a new building within the sector, say a mall or a large office block.

In other cases, load unbalance could be of temporary nature, changing periodically (for example, according to time of the day or day of the week) or it could be event driven.

Thus it might be advantageous to dynamically balance the load between sectors, by transferring some load from a heavily loaded sector to other sectors which are lightly loaded.

Patent applications WO 02/061878 “ANTENNA ARRANGEMENTS FOR FLEXIBLE COVERAGE OF A SECTOR IN A CELLULAR NETWORK”, and U.S. Provisional Patent Application No. 60/442,890 filed Jan. 28, 2003 “SYSTEM AND METHOD FOR LOAD DISTRIBUTION BETWEEN SECTORS, describe an approach based on changing the direction (azimuth) and width of the sectors, by controlling the shape of the antenna patterns.

By narrowing a heavily loaded sector while widening other lightly loaded sectors we can balance the load in the cell and improve overall system performance.

Another approach is to reduce the load of a heavy loaded sector by tilting the antenna and thus shrinking the range of the sector (and of the cell in that direction), transferring the load to the neighboring cell. This could be done in conjunction with the previously mentioned cell shaping. Whilst cell-shaping works and is quite widely used it is mainly applicable where overload usage is linear and less where it is in the form of temporary hotspots.

There is thus a widely recognized need for, and it would be highly advantageous to have, a load balancing system devoid of the above limitations. Any solution should also be readily applicable to legacy base stations.

### SUMMARY OF THE INVENTION

The present invention describes a load sharing mechanism for sector based cellular base stations for preventing hot-spot type overload from overwhelming a given sector on a base station. In one embodiment loads in hot-spots in one sector are switched over to be served by sectors which are less loaded. The hotspots are covered by repeaters or like relay devices and load sharing is achieved by reassigning the repeaters to different sectors. Where the principle cause of overload is changes within the hotspots then reassigning the repeaters is a more efficient way of load balancing than traditional changing of the antenna patterns or shaping the sectors or the cell. A system according to the present embodiments can be applied to an existing base station that does not require any modification to the baseband part of the base station, and a preferred embodiment uses the existing base station antennas for communicating with the repeaters.

An alternative embodiment uses the existing sectors of the base station for regular traffic and uses an additional dedicated sector specifically for repeater or relay traffic.

In the above, the load balancing may be applied for adapting to slow changes, or to periodic changes or it may be event driven. In some cases load balancing is initiated by the operator, and once load balance is achieved the process typically stops until further initiated.

In other cases it may be performed continuously, initiated automatically by detection of load imbalances.

According to one aspect of the present invention there is provided a load balancing system for dynamic balancing of load between sectors of local sectored cellular base stations, the system comprising:

a plurality of repeaters for providing local coverage within the sectors, and

a switch, for associating between the repeaters and a respective one of the local sectored base stations, and for switching the repeaters between different sectors.

Preferably, the switch comprises a switching matrix for permitting connections between ones of the plurality of repeaters and each sector of a respective base station

Preferably, the switching matrix comprises a control mechanism for controlling the switching matrix to switch ones of the repeaters from a currently heavily loaded sector to a currently lightly loaded sector.

Preferably, the switching matrix has a base station side and a repeater side and the base station side is connected to RF outputs of a respective sectored base station.

Preferably, the repeater side has a plurality of connections, each for a different repeater and each output is associated with a frequency converter.

Preferably, the frequency converters are configured for converting between an assigned base station RF frequency (F1) and another frequency (F2) within the same cellular band as an assigned base station RF frequency, thereby allowing legacy antennas of the base station to be used for communicating with the repeaters.

Preferably, the assigned base station RF frequency and the another frequency are both multi-carrier frequencies.

In an embodiment, respective repeaters are tuned to different frequencies.

Preferably, the another frequency is in a different frequency band from a base station assigned frequency and additional antennas are applied to the base station for communicating with the repeaters.

An embodiment may use an omni-antenna applied to a respective base station for communicating with the repeaters.

Preferably, the switching matrix is remotely located from a respective cellular base station and is connected thereto via a communication link.

Preferably, the communication link is a radio link.

In an embodiment, the communication link is a directional communication link.

In an alternative embodiment, the communication link is an optical link.

In a further alternative embodiment, the communication link is a microwave link.

In one embodiment, the repeater is connected to the switching matrix by radio link.

Alternatively, the repeater is connected to the switching matrix by a directional link.

Alternatively, the repeater is connected to the switching matrix by optical link.

Alternatively, the repeater is connected to the switching matrix via a microwave link.

Preferably, at least one of the repeaters has connections to a plurality of switching matrices, thereby allowing it to be associated with sectors from different base stations.

Additionally or alternatively, at least one of the repeaters is assignable between sectors of at least two different base stations.

Preferably, the control mechanism is responsive to a per-sector load sensing mechanism.

Preferably, the control mechanism comprises an optimization algorithm that takes an output of the per-sector load sensing mechanism and efficiently reassigns the repeaters between the sectors to balance the load.

Preferably, the per-sector load sensing mechanism is sensitive to total transmitted power per sector.

Additionally or alternatively, the per-sector load sensing mechanism is sensitive to a current number of users per sector.

Additionally or alternatively, the per sector load sensing mechanism is sensitive to uplink received power.

Additionally or alternatively, the per-sector load sensing mechanism is sensitive to total transmitted power per sector and a current number of users per sector.

The system may comprise a per repeater load sensing mechanism associated with the per sector load sensing mechanism.

The system may comprise a load differentiator for differentiating between a direct load of the sector and a contribution to the load from the repeaters.

Preferably, the differentiator is configured to mark the repeater signal and to monitor the mark.

Preferably, the differentiator is configured to measure an uplink repeater signal at the switching matrix.

In one preferred embodiment one of the base stations comprises an additional sector dedicated for repeater traffic.

According to a second aspect of the present invention there is provided a load balancing system for dynamic balancing of load between sectors of local sectored cellular base stations, the system comprising:

a plurality of repeaters for providing localized coverage within the sectors,

an additional sector at a respective base station for handling repeater traffic, and

a switch, for associating between the repeaters and the additional sector.

According to a third aspect of the present invention there is provided a method of load balancing at a sector-based cellular base station whose traffic has temporary hot spot characteristics, the method comprising:

assigning a repeater to at least one of the hotspots,

associating the repeater with a switching matrix,

connecting the switching matrix to allow switching of the at least one repeater between sectors of the sector-based cellular base station,

measuring usage load at respective ones of the sectors, and

controlling the switching matrix to switch the at least one repeater between the sectors in order to achieve balancing of the usage load between the sectors.

According to a fourth aspect of the present invention there is provided a method of upgrading an existing sector-based cellular base station using repeaters, the upgrade to enable dynamic load balancing, the upgrade comprising:

attaching a switching matrix to respective sector RF connections of the base station,

assigning respective connections of the switching matrix to the repeaters,

obtaining an output from the base station indicating sector usage loading, and

connecting the obtained output to control the switching matrix to switch the repeaters between the sector RF connections, thereby to enable balancing of repeater-based load between the sectors.

According to a fifth aspect of the present invention there is provided a method of load balancing between sectors of a cellular base station, the sectors having repeaters, the method comprising:

measuring load at respective sectors of the cellular base station,

determining whether there are sectors that are overloaded and underloaded, and

for each overloaded sector, switching at least one repeater therefrom to another sector.

Preferably, the at least one repeater is a repeater from another sector currently connected via a respective overloaded sector.

Alternatively, the at least one repeater is a repeater from the currently overloaded sector.

Preferably, the switching comprises switching a single repeater and the measuring, determining and switching are repeated iteratively until no sector is overloaded.

Preferably, the switching comprises switching a single repeater and the measuring, determining and switching are repeated iteratively until it is apparent that a state in which no sector is overloaded is currently unattainable.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a simplified block diagram showing hot-spots within sectors of a cellular base station;

FIG. 2 is a simplified block diagram showing a first preferred embodiment for dynamically switching repeaters between sectors using a switching matrix according to a first preferred embodiment of the present invention;

FIG. 3 is a simplified block diagram showing a second preferred embodiment of the present invention in which two base stations are able to switch repeaters between them;

FIG. 4 is a simplified block diagram showing a third preferred embodiment of the present invention, in which base stations are provided with a fourth sector dedicated to traffic from repeaters;

FIG. 5 is a simplified schematic diagram illustrating an embodiment of the present invention in which an RF link is provided to the repeaters using existing antennae of the base station;

FIG. 6 is a simplified schematic diagram illustrating an embodiment of the present invention in which dedicated links are used to connect the repeaters to respective connections of the switching matrix; and

FIG. 7 is a simplified schematic diagram illustrating an embodiment of the present invention in which an omni-directional antenna is used to transmit the repeater signals irrespective of which sector they have been assigned to.

FIG. 8 is a simplified flow chart showing a load balancing algorithm for balancing repeaters between the different sectors of a cellular base station or stations.

FIG. 9 is a flow chart illustrating a modification of the load balancing algorithm of FIG. 8.

FIG. 10 is a simplified flow chart showing in greater detail the balancing phase of the load balancing algorithm of FIG. 8.

### DESCRIPTION OF THE PREFERRED EMBODIMENTS

In the present embodiments we consider a sectored cell, where hot-spots in each sector are local, each served by its own repeater, and may draw high capacity at different times. Load sharing is applied between sectors by connecting repeaters which are located in one sector (the loaded sector) to other sectors which are less loaded. This is accomplished by connecting the repeater to the donor sector base station using frequency F2. The repeater converts the transmission back to F1, the original frequency of the donor base station. Softer handoff is applied between the repeaters and the sectors in which they are located.

Load balancing is performed and maintained by using a control subsystem, which measures the load in each sector, as well as the load served by each repeater, and an optimization algorithm, which dynamically assigns repeaters to sectored base stations, using a switching matrix.

The principles and operation of a load balancing system according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

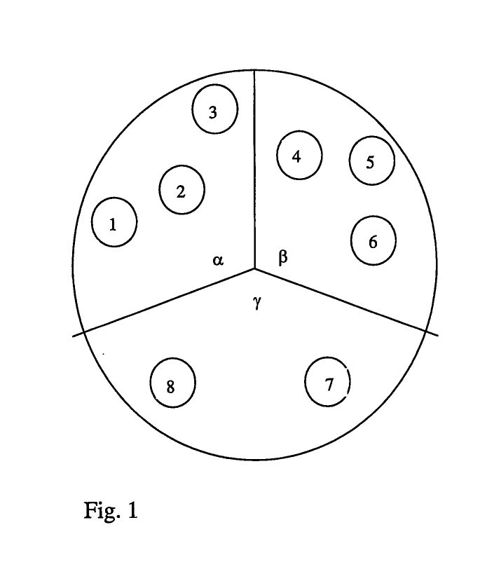

Reference is now made to FIG. 1, which is a simplified block diagram showing three sectors α, β, and γ of a base station. The base stations have uneven loading patterns where at least some of the load comes from hotspots. In the figure, hotspots 1, 2 and 3 are local to sector α. Hotspots 4, 5 and 6 are local to sector β, and hotspots 7 and 8 are local to sector γ. The hotspots are typically large office buildings, shopping malls, railway stations and the like, and each hotspot has its own dynamic. Thus an office building is a major source of activity at work hours during the week. A shopping mall is active during working hours but tend to get more active later in the day. A railway station is particularly active during rush hour.

One way of serving a hotspot is to provide it with a repeater, a dedicated antenna sited for good coverage of the hotspot. Such a repeater allows for good reception within the hotspot and more importantly increases capacity at the hotspot. Depending on the cellular system in use, the reason the repeater increases capacity is that since the repeater is closer or otherwise well situated, the amplitude needed for signals within the hotspot is lower and thus interference is lower, allowing more communication to be packed into the channels.

FIG. 1 illustrates a situation where hot spots are local to each sector. As explained, the hot spots may draw high capacity at different times. Thus at a certain time of day sector a may be lightly loaded whereas sector β is heavily loaded. Furthermore much of the load on β comes from its hotspots 4, 5, and 6. It may thus be desired to draw, at a given time, spare capacity from sector α, for example, to the hotspots 4,5,6 which are located within the coverage area of sector β. This way, the lightly loaded sector a takes some of the load of the heavy loaded sector β.

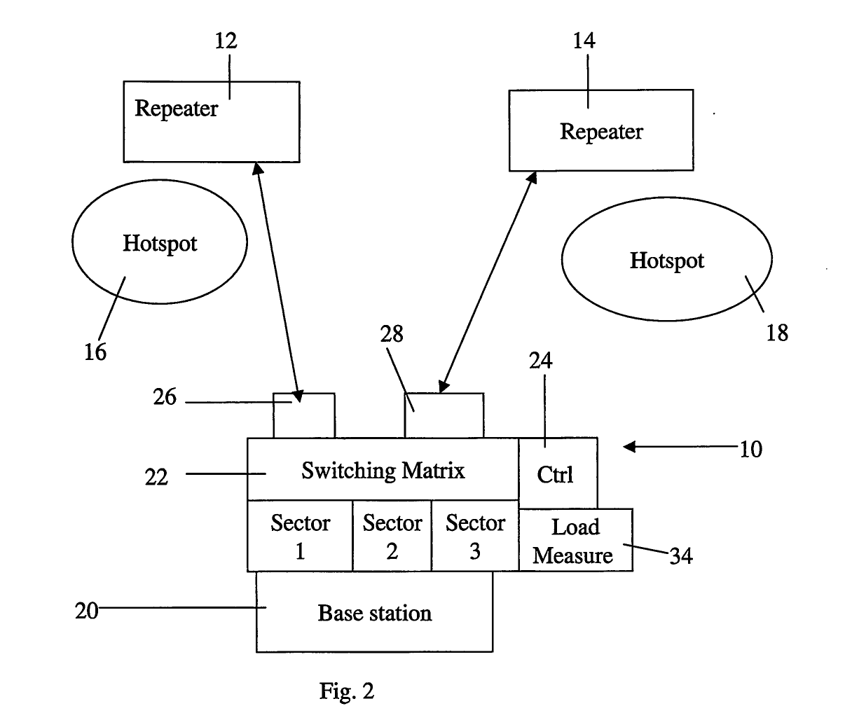

Reference is now made to FIG. 2, which is a simplified diagram illustrating a cellular base station system for load balancing by transferring repeater load from one sector to another dynamically as loading changes between the sectors. The load balancing system 10 comprises a plurality of repeaters 12, 14, to give local coverage for hotspots 16 and 18 in a respective sector. A base station 20 has three sectors 1, 2 and 3 respectively, to which conventionally the repeaters would connect directly so that a repeater say in sector 1 would connect directly to sector 1, and a repeater in sector 2 would connect directly to sector 2. However, instead of the direct connection, the repeaters are connected to a switching matrix 22. Switching matrix 22 has a connection to each repeater and also a connection to each sector of the base station so that any repeater can be switched to any base station as desired.

Preferably, the switching matrix comprises a control mechanism 24 for controlling the switching matrix to switch the repeaters from a currently heavily loaded sector to a currently lightly loaded sector, as explained above.

The switching matrix is preferably connected to RF outputs of the base station typically having one input/output for each sector. At the other side of the switching matrix it preferably has an input/output connection for each repeater. The switching matrix is preferably able to establish connections between each sector input/output and each repeater input/output.

In one embodiment, each switching matrix-repeater input/output connection is associated with a frequency converter 26, 28, so that a different frequency can be used for communicating with each repeater, independently of the frequency band in use in the sector. Hence the repeater can be switched between sectors without having to change its frequency.

In one embodiment, the frequency converters are configured for converting between an assigned base station RF frequency (F1) and another frequency (F2), the repeater frequency, within the same cellular band as the assigned base station RF frequency (F1). This means that the legacy antennas of the base station can be used for communicating with the repeaters, and no new antennas need to be added to the base station.

It will be appreciated that either or both of the assigned base station RF frequency and the repeater frequency may be multi-carrier frequencies.

Preferably, different repeaters are tuned to different frequencies, so that they can be assigned between sectors without fear of interference.

In another preferred embodiment, the repeater frequency (F2) is in a different frequency band from the base station assigned frequency, for example in the Microwave band. In such a case additional antennas, typically directional microwave antennas, are applied to the base station for communicating with the repeaters, or with the switching matrix if it is located remotely from the base station.

In another preferred embodiment, an omni-antenna or omni-directional antenna may be applied to the base station for communicating with the repeaters.

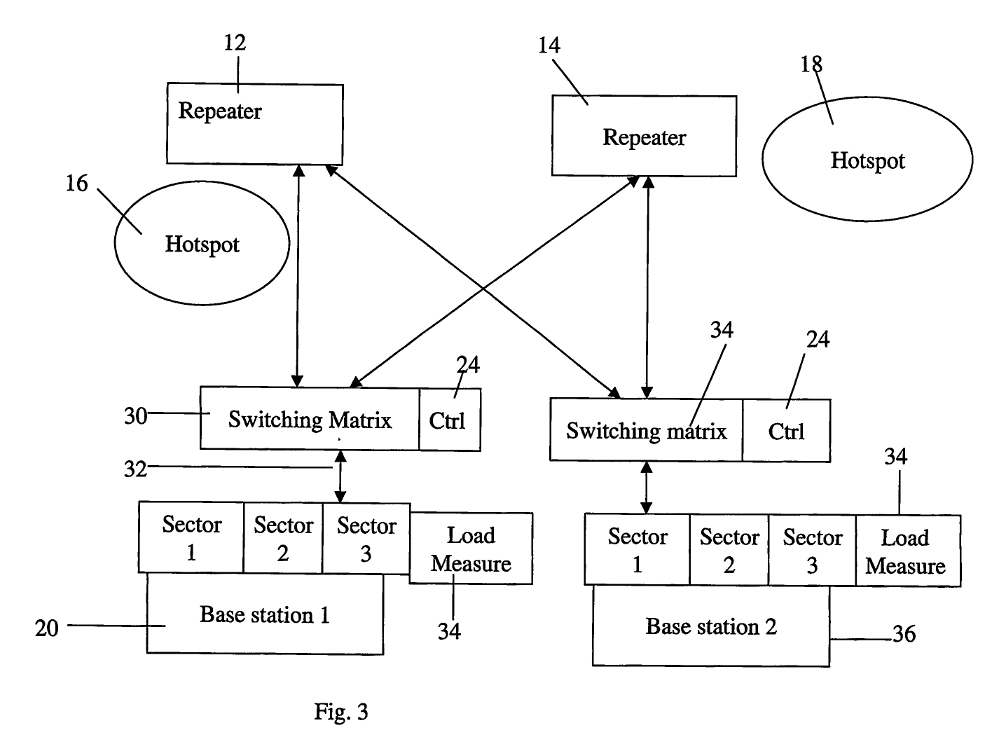

Reference is now made to FIG. 3, which is a simplified diagram showing a further preferred embodiment of the present invention. In FIG. 3, a switching matrix 30 is remotely located from cellular base station 20 and is connected thereto via a communication link 32. Parts that are the same as in previous figures are given the same reference numerals and are not referred to again except as necessary for understanding the present embodiment. The communication link 32 may be a radio link, which, as with the repeater links, may be in the same frequency band as that assigned to the base station, thus allowing the legacy antennas to be used. Alternatively the radio link may use a different frequency band, entailing the installation of additional antennas at the base station. The communication link 32 may in such a case be an optical link or a microwave link or a wire link or any other suitable communication link.

It is noted that when the communication link 32 relays the signals of all the repeaters it is preferably a microwave link (with dedicated antennas) or a fiber link. It cannot be in the same frequency band as the base station since there is unlikely to be enough capacity, and thus it cannot use the legacy antennas.

As shown in FIG. 3, a second switching matrix 34 is provided. The second switching matrix is connected via a communication link to a second base station 36. In a preferred embodiment, repeaters 12 and 14 can be picked up by either switching matrix and assigned to any of the sectors in either of the base stations. It will be appreciated that the ability to be picked up by either switching matrix is irrespective of whether the switching matrix is remotely located from a given base station. However it is noted that one of the reasons for remote location of the switching matrix is to provide optimal reception for the repeaters.

The skilled person will appreciate that if two or more base stations serve the same repeaters, then since the switching matrices are placed to have good communication with the repeaters, it may be simpler to have a single switching matrix serving both base stations using two communication links (32), instead of having two switching matrices each with separate sets of repeater links.

As shown, each switching matrix has a control mechanism 24 to set the switches across the switching matrix. In a preferred embodiment the control mechanism is responsive to a per-sector load sensing mechanism 34 at the base station. The load sensing mechanism 34 may sense load in terms of a number of active callers, or in terms of total transmitted power, or noise on the uplink or a combination of the above or any other suitable load measurement.

Control mechanism 24 preferably makes use of an optimization algorithm that takes an output of the per-sector load sensing mechanism and optimally reassigns the repeaters between the various sectors to balance the load. The optimization algorithm may additionally make use of load measurements at the repeaters.

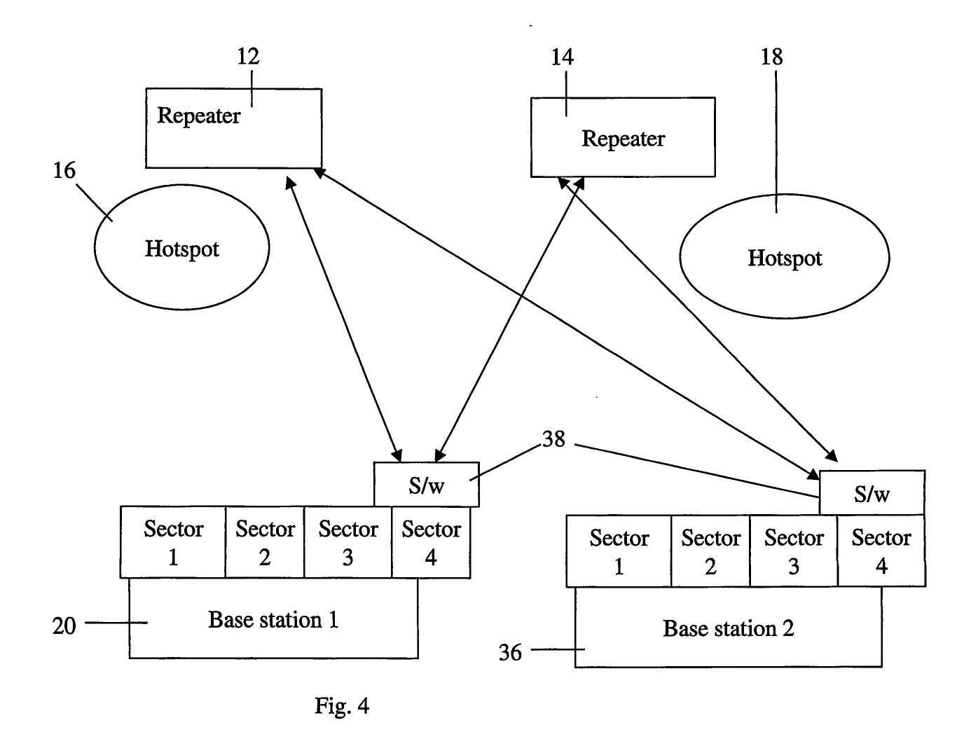

Reference is now made to FIG. 4, which is a simplified diagram illustrating a further preferred embodiment of the present invention. Parts that are the same as in previous figures are given the same reference numerals and are not referred to again except as necessary for understanding the present embodiment. In FIG. 4, load balancing between the sectors at base station 20 is achieved by building into the base station a fourth sector. The repeaters are all directed to the fourth sector, allowing the remaining three sectors to deal with non-hotspot traffic. In a further preferred embodiment, switches 38 allow the individual repeaters to be switched between two nearby base stations, allowing further load balancing.

It is reiterated at this point that it is possible to use fiber linking to each repeater, or any other point-to point linking, or it is possible to use RF linking to the repeaters.

It is further possible to make use of the availability of one or multiple cellular/PCS band frequencies, unused in this cluster of cells. It is alternatively possible to make use of another multicarrier band, for example an unlicensed band such as 5.8 GHz, for the linkage between the BTS and the repeaters

It is noted that the additional sector dedicated to the repeaters is valid for the single base station situation as well as for the multiple base station situation, that is it is an extension of FIG. 2 rather than FIG. 3.

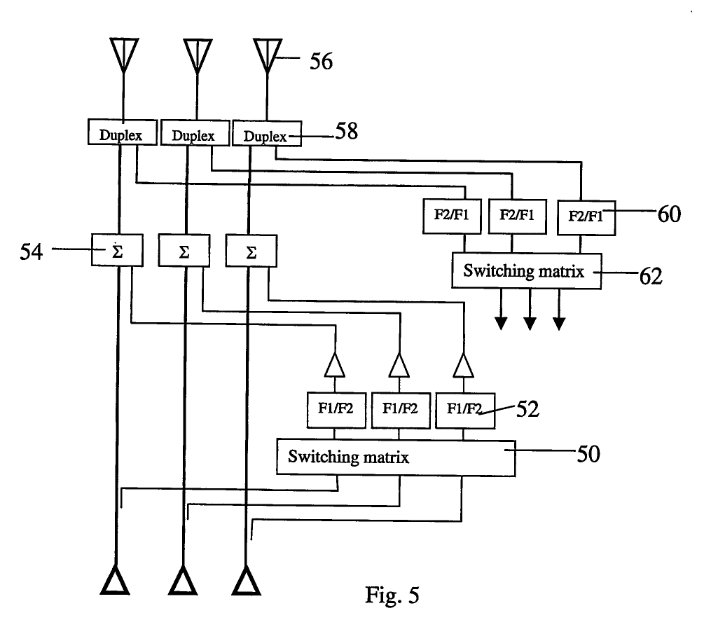

In a preferred embodiment of the present invention the RF linking to the repeaters is made using an unused frequency or frequencies in the PCS/Cellular band, using the existing transmit/receive antennas. A schematic of such a system is shown in FIG. 5 which illustrates an attachment for a three-sector base station to transmit and receive signals via a switching matrix to repeaters. For each of the three sectors a signal for the repeaters is sent to transmit switching matrix 50. In FIG. 5, frequency F1 is the carrier frequency used by all sectors to communicate with the mobile subscribers. F2 is the carrier frequency used by all sectors to communicate with the repeaters. The per-sector transmission is translated from F1 to F2 by transmit frequency converters 52 before being transmitted to the repeaters. Transmission is via the existing antennas.

The switching matrix 50 assigns the transmission of one sector to the repeaters of any sector (including its own). It can switch one sector to the repeaters of two (or even three) sectors.

Combiners 54 combine the repeater signal with the regular signal on to the base station antennas 56. Note that combiners are required if the repeater transmission is to be made from the BTS sector antennas. The combiners may entail a loss, which is avoidable if transmission can be made from separate antennas. Availability of separate sector antennas is a matter of licensing and cost. A diversity receive-only antenna can also be duplexed for this purpose.

A similar system is provided on the receive side of the base station with the receive signal extracted by duplexers 58, converted back to the original frequency F1 by receive frequency converters 60 and then switched to the appropriate sectors via receive switching matrix 62.

There are several configurations of the embodiment of FIG. 5 as follows:

a) Single carrier (F1) translated into a single link frequency (F2)

b) Multi carrier frequencies to multi-carrier frequencies, where such carriers are available and not in use in that cluster. In such a case there is a translation from a number of carriers in use (F1 group), one-to-one, to another set of carriers (F2 group). Repeaters may be broadband, translating from F2 group back to F1 group. The resource allocation control in this case is per sector.

c) Individual repeaters may be tuned to a different carrier in the F2 group, which is then translated to the respective F1 group members. This offers an additional degree of resource allocation control, at the individual repeater level.

It is noted that if F1 is the carrier frequency, and we have several unused F2 frequencies in the same band, it is possible to differentiate between repeaters by using different F2 frequencies, and have an added degree of freedom for resource allocation. However, in the multicarrier case (F1 group) it is less likely to have enough unused F2 group frequencies to accommodate the separate frequency allocation

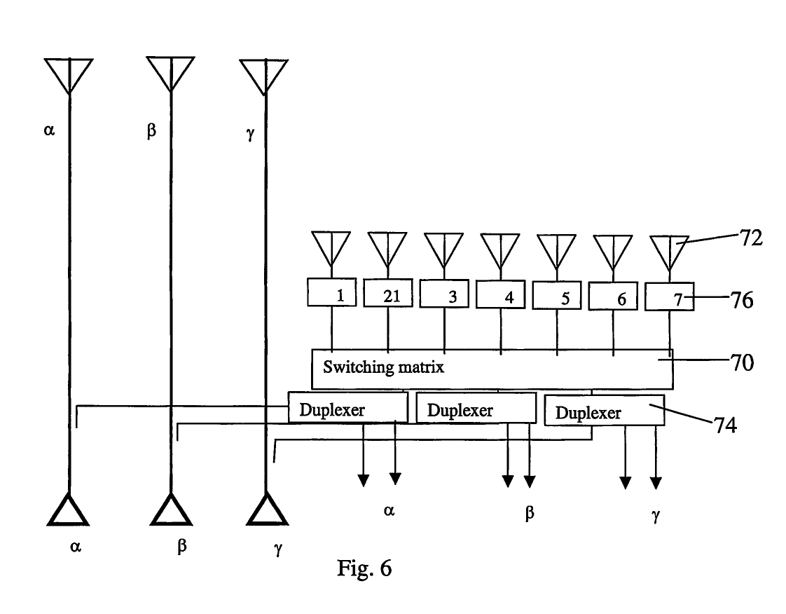

Reference is now made to FIG. 6 which illustrates an alternative embodiment of the present invention. In FIG. 6, a point-to-point microwave linkage between the repeaters and the BTS is provided using dedicated antennas (one for each repeater).

The three sector signals emerge from the base station and the repeater signals are routed to switching matrix 70. From switching matrix 70 the repeater signals are sent to point to point antennas 72 for transmission to the repeaters. The point to point antennas 72 also receive signals from the repeaters which are switched back through the switching matrix and combined with the regular signals of the sector to which they have been switched. Duplexers 74 allow for switching between transmit and receive signals.

RF converters 76, located between the switching matrix and the point to point antennas 72, translate the base frequency (F1) to the repeater link microwave frequency (FMW).

The configuration of FIG. 6 allows the switching matrix to control each one of the access points and may link each repeater to any desired sector. The gain of each access point is controlled from the central command, thus controlling the coverage and capacity each access point draws.

In this and other embodiments, a coupler may be attached before the power amplifier subject to accessibility.

The linkage can further be embodied by use of RF transmission between the BTS and the switching matrix, in a case where there is an advantage to physical separation between the BTS and the repeater distribution complex. Such a case is shown in FIG. 3 described above.

Also, as shown in FIG. 4, a full sector may be dedicated to the remote extensions, that is to say to the repeaters. In such a case the switching matrix is fed by a single input. The use of such a dedicated sector, typically a fourth sector, is a method to increase the cell's capacity, without changing the geographical setup.

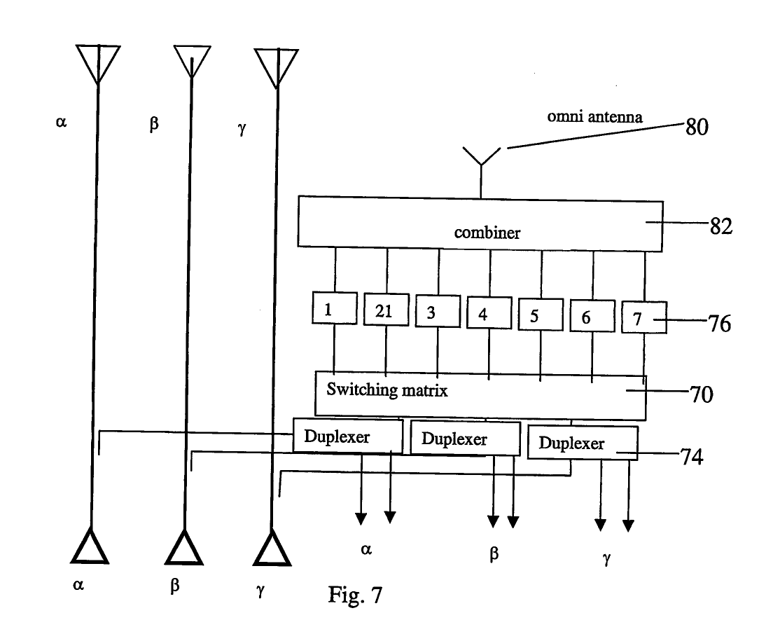

Reference is now made to FIG. 7, which illustrates yet another embodiment of the present invention, in which the RF linkage to the repeaters is made using one omni antenna, 80 and separation is achieved in the frequency domain. Parts that are the same as in previous figures are given the same reference numerals and are not referred to again except as necessary for understanding the present embodiment. Combiner 82 combines the signals from the frequency converters 76 onto the omni antenna. Each repeater or group of repeaters is assigned a different unused frequency in the PCS/Cellular band.

Load Measurements

Load measurements are required for any kind of load balancing and network optimization, whether the balancing is done manually to adapt the network to slow changes, or dynamically using optimization algorithms.

Since the load balancing of the present embodiments involves repeaters, the contribution of each repeater should be known, as well as the total load of each sector. Furthermore, the load should be monitored periodically, especially when dynamic optimization is required.

Any efficient load measuring technique and method can be used. Examples of available techniques are uplink measurements (noise rise), downlink measurements (total transmitted power), counting the number of users (at the sector level), or a combination of these techniques.

Similarly, any technique and method for the differentiation between the direct load of the sector and the contribution of the load through the repeaters can be used. For example, marling the repeater signal (in the downlink or in the uplink) and monitoring the mark, or measuring the uplink repeater signal at the switching matrix.

Once the loads are determined, we can use an efficient algorithm to perform the load balancing.

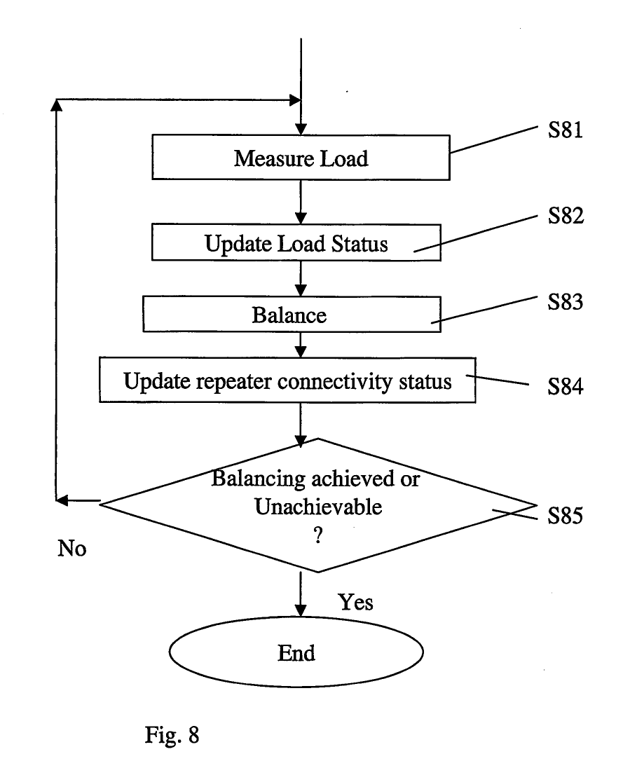

Reference is now made to FIG. 8, which is a simplified flow chart illustrating a generalized algorithm for load balancing by switching of repeaters between different sectors. As shown in FIG. 8, load balancing begins with a load measuring phase S81, in which the load in the different cells is measured. In stage S82, the load parameters are updated in response to the measurements obtained in the measurement phase. In stage S83, the load is balanced between the cells by moving repeaters around the cells as necessary. Then in stage 84 the repeater connectivity status vector is updated. Decision stage S85 then stops the process if either the system is balanced or if balance appears to be unattainable. Otherwise the process is repeated.

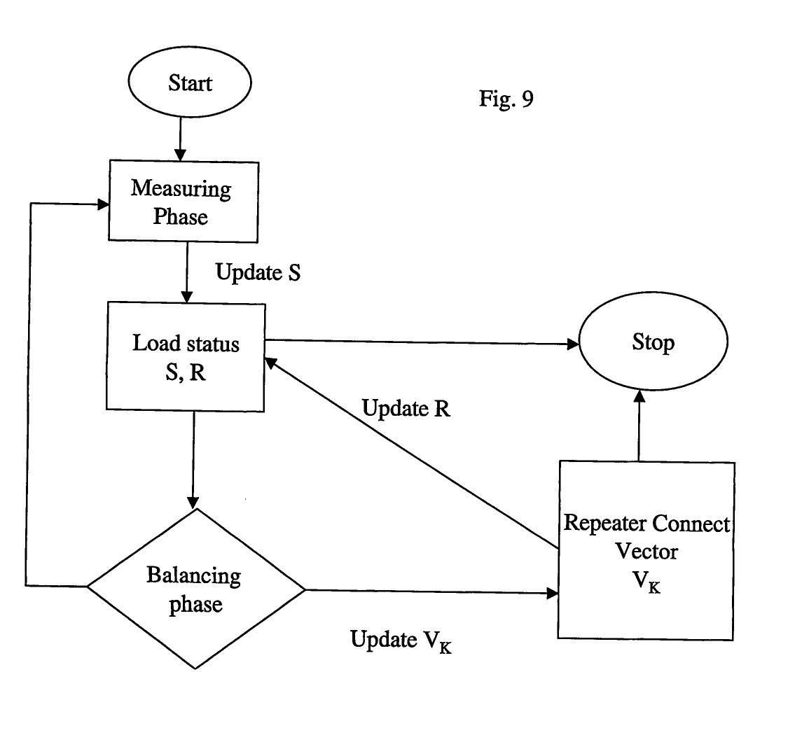

Reference is now made to FIG. 9, which shows the process of FIG. 8 in greater detail according to one preferred embodiment of the load balancing algorithm.

The algorithm operates recursively (in steps), in two phases: a measuring phase and a balancing phase, as before. However, after each individual phase the system status is updated, and a decision is made whether to continue (go to the next phase) or to end the process.

More particularly the load balancing cycle can be started either manually (operator initiated) or automatically (clock driven or event driven). In FIG. 9, S represents load status of the sectors and R represents the assignment of repeaters amongst the sectors.

The system status includes:

1) load status (per sector)
SA=1 if sector A is overloaded and needs support from other resources, to relieve some of its load.
SA=−1 if sector A is lightly loaded and has available resources to assist other heavy loaded sectors.
Otherwise SA=0

Also, RA=1 if there are repeaters (at least one), located in other sectors, and using Sector A's resources (i.e. connected to sector A)
Otherwise RA=0

2) Repeater connectivity status

Vector V, with entries vi, [i=1, . . . , P] indicates to which sector (if any) repeater i is connected (vi=A, B, C or 0).

P is the number of repeaters.

Measuring Phase

For each sector involved (typically 3 sectors), we measure some or all of the load parameters as follows:

1) Pr—Total received power in the uplink

2) Pt—Total transmitted power in the downlink

3) N—Total number of users served by the sector

We further set threshold parameters (system parameters) thus:
Upper threshold Ur, Ut, UN
Lower threshold Lr, Lt, LN

Then using the measurements and the thresholds we may proceed as follows to update the load status:

If Pr>Ur or Pt>Ut or N>UN set S=1

If Pr<Lr and Pt<Lt and N<LN set S=−1
Otherwise set S=0

After going through the measuring phase the load status is updated.

The balancing phase

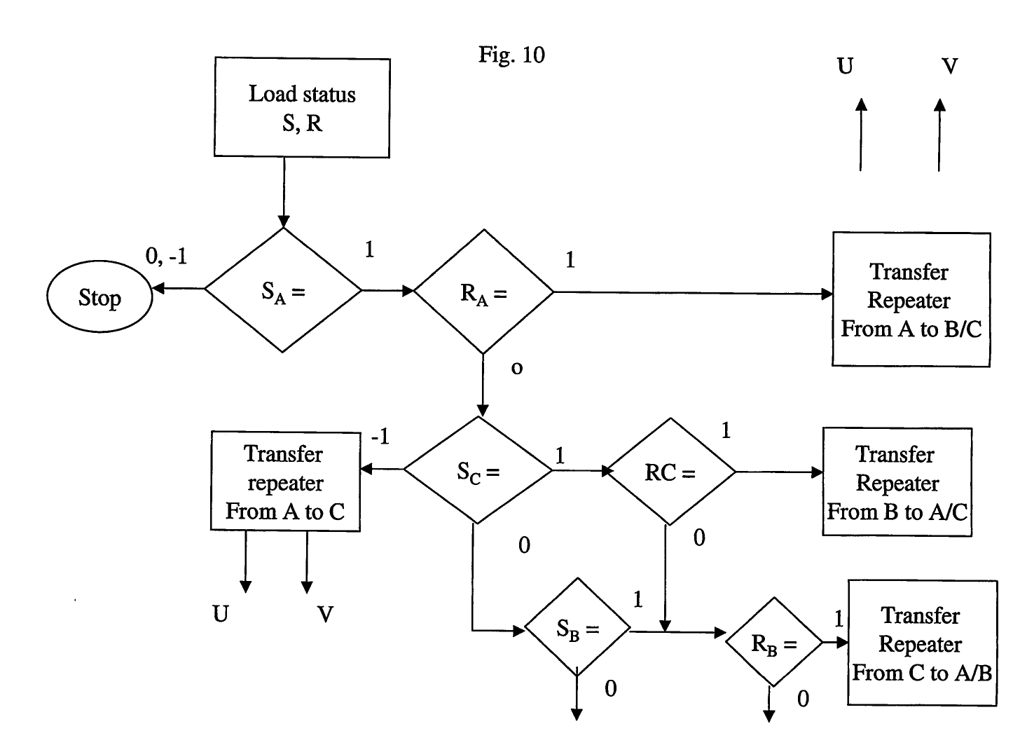

Reference is now made to FIG. 10, which is a further flow diagram illustrating a preferred embodiment of the balancing phase.

In FIG. 10, we assume without loss of generality that sector A is the most loaded sector, and sector C is the least loaded one, i.e. SA>=SB>=SC

The legend U indicates returning to the measuring phase, S81 in FIG. 8, and V indicates proceeding to the update repeater connect vector phase, S84 in FIG. 8.

If the load status shows that (at least) one sector is overloaded (Max(SA,SB,SC)=1), we go to the balancing phase.

In the balancing phase we try to relieve the overload of the loaded sector (say A) by first removing the connection to a repeater actually located in another sector which in fact loads sector A. If no such a repeater exists, meaning that A is not loaded by repeaters from other sectors, then we may try to connect a repeater located in A to resources of another sector.

In every step preferably at most one repeater is added or removed.

Following the balancing process we update the repeater connectivity vector and go to the measuring phase to begin the next step.

Returning to FIG. 8, and the balancing algorithm is repeated in iterative stages of which each stage comprises:

a measuring phase

an update of the load status

a balancing phase, and

an update of the repeater connectivity status.

As the stage is completed we repeat the process by returning to the measuring phase.

At the start of the process we have the initial status of the repeater connectivity vector V, which we denote by V0.

As the process progresses, we have at each step k an update of the repeater connectivity vector Vk.

We store all vectors Vk (k=0, 1, 2, . . .) belonging to the current balancing cycle. (that is all Vj since the start of this cycle)

The balancing cycle ends when load balancing has been successfully achieved, that is when no sector is overloaded (Max(SA,SB,SC)<=0

The balancing cycle also ends if load balancing cannot be achieved, that is when we do not have enough resources in the system however the load is distributed.

This situation is identified when at step k we have a repeater connectivity Vk which is equal to Vj at some previous step j<k.

In this case, the base station preferably resorts to other methods for relieving the load, such as cell shaping, tilting, updating access parameters etc.

Also, if the load contribution of each repeater is measured and known, it can be used in choosing which repeater to disconnect.

It is expected that during the life of this patent many relevant cellular communication systems will be developed and the scope of the terms herein, particularly of the terms “cellular” and “sector”, are intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. A load balancing system for dynamic balancing of load between sectors of local sectored cellular base stations, the system comprising:
a plurality of repeaters for providing local coverage within the sectors, and
a switch, for associating between the repeaters and a respective one of said local sectored base stations, and for switching the repeaters between different sectors.

2. The system of claim 1, wherein said switch comprises a switching matrix for permitting connections between ones of said plurality of repeaters and each sector of a respective base station

3. The system of claim 2, wherein said switching matrix comprises a control mechanism for controlling said switching matrix to switch ones of said repeaters from a currently heavily loaded sector to a currently lightly loaded sector.

4. The system of claim 2, wherein said switching matrix has a base station side and a repeater side and wherein said base station side is connected to RF outputs of a respective sectored base station.

5. The system of claim 4, wherein said repeater side has a plurality of connections, each for a different repeater and wherein each output is associated with a frequency converter.

6. The system of claim 5, wherein said frequency converters are configured for converting between an assigned base station RF frequency (F1) and another frequency (F2) within the same cellular band as an assigned base station RF frequency, thereby allowing legacy antennas of said base station to be used for communicating with said repeaters.

7. The system of claim 6 wherein assigned base station RF frequency and said another frequency are both multi-carrier frequencies.

8. The system of claim 6, wherein respective repeaters are tuned to different frequencies.

9. The system of claim 6, wherein the another frequency is in a different frequency band from a base station assigned frequency and wherein additional antennas are applied to said base station for communicating with said repeaters.

10. The system of claim 1, further comprising an omni-antenna applied to a respective base station for communicating with said repeaters.

11. The system of claim 2, wherein said switching matrix is remotely located from a respective cellular base station and is connected thereto via a communication link.

12. The system of claim 11, wherein said communication link is a radio link.

13. The system of claim 11, wherein said communication link is a directional communication link.

14. The system of claim 11, wherein said communication link is an optical link.

15. The system of claim 11, wherein said communication link is a microwave link.

16. The system of claim 2, wherein said repeater is connected to said switching matrix by radio link.

17. The system of claim 2, wherein said repeater is connected to said switching matrix by a directional link.

18. The system of claim 2, wherein said repeater is connected to said switching matrix by optical link.

19. The system of claim 2, wherein said repeater is connected to said switching matrix via a microwave link.

20. The system of claim 2, wherein at least one of said repeaters has connections to a plurality of switching matrices, thereby allowing it to be associated with sectors from different base stations.

21. The system of claim 1, wherein at least one of said repeaters is assignable between sectors of at least two different base stations.

22. The system of claim 3, wherein said control mechanism is responsive to a per-sector load sensing mechanism.

23. The system of claim 22, wherein said control mechanism comprises an optimization algorithm that takes an output of said per-sector load sensing mechanism and efficiently reassigns said repeaters between said sectors to balance said load.

24. The system of claim 22, wherein said per-sector load sensing mechanism is sensitive to total transmitted power per sector.

25. The system of claim 22, wherein said per-sector load sensing mechanism is sensitive to a current number of users per sector.

26. The system of claim 22, wherein said per sector load sensing mechanism is sensitive to uplink received power.

27. The system of claim 22, wherein said per-sector load sensing mechanism is sensitive to total transmitted power per sector and a current number of users per sector.

28. The system of claim 22, further comprising a per repeater load sensing mechanism associated with said per sector load sensing mechanism.

29. The system of claim 22, further comprising a load differentiator for differentiating between a direct load of the sector and a contribution to the load from said repeaters.

30. The system of claim 29, wherein said differentiator is configured to mark the repeater signal and to monitor the mark.

31. The system of claim 29, wherein said differentiator is configured to measure an uplink repeater signal at said switching matrix.

32. The system of claim 1, wherein at least one of said base stations comprises an additional sector dedicated for repeater traffic.

33. A load balancing system for dynamic balancing of load between sectors of local sectored cellular base stations, the system comprising:
a plurality of repeaters for providing localized coverage within the sectors,
an additional sector at a respective base station for handling repeater traffic, and
a switch, for associating between the repeaters and said additional sector.

34. A method of load balancing at a sector-based cellular base station whose traffic has temporary hot spot characteristics, the method comprising:
assigning a repeater to at least one of said hotspots,
associating said repeater with a switching matrix,
connecting said switching matrix to allow switching of said at least one repeater between sectors of said sector-based cellular base station,
measuring usage load at respective ones of said sectors, and
controlling said switching matrix to switch said at least one repeater between said sectors in order to achieve balancing of said usage load between said sectors.

35. A method of upgrading an existing sector-based cellular base station using repeaters, said upgrade to enable dynamic load balancing, the upgrade comprising:
attaching a switching matrix to respective sector RF connections of said base station,
assigning respective connections of said switching matrix to said repeaters,
obtaining an output from said base station indicating sector usage loading, and
connecting said obtained output to control said switching matrix to switch said repeaters between said sector RF connections, thereby to enable balancing of repeater-based load between said sectors.

36. A method of load balancing between sectors of a cellular base station, the sectors having repeaters, the method comprising:
measuring load at respective sectors of the cellular base station,
determining whether there are sectors that are overloaded and underloaded, and
for each overloaded sector, switching at least one repeater therefrom to another sector.

37. The method of claim 36, wherein said at least one repeater is a repeater from another sector currently connected via a respective overloaded sector.

38. The method of claim 36, wherein said at least one repeater is a repeater from said currently overloaded sector.

39. The method of claim 36, wherein said switching comprises switching a single repeater and said measuring, determining and switching are repeated iteratively until no sector is overloaded.

40. The method of claim 36, wherein said switching comprises switching a single repeater and said measuring, determining and switching are repeated iteratively until it is apparent that a state in which no sector is overloaded is currently unattainable.
